(19) United States
(12) Patent Application Publication
(10) Pub. No.: US 2003/0222831 A1
(43) Pub. Date: Dec. 4, 2003

(54) Three-dimensional spatial division multiplexing access (3D-SDMA) antenna system

(76) Inventor: Brian Dunlap, Newark, IL (US)

Correspondence Address: Welsh & Katz, Ltd., John R. Garrett, Esq., 22nd Floor, 120 South Riverside Plaza, Chicago, IL, 60606, US

(21) Appl. No.: 10/159,439

(22) Filed: May 31, 2002

(51) Int. Cl. H01Q 21/00; H01Q 1/24

(52) U.S. Cl. 343/893; 343/702

(57) ABSTRACT

A three-dimensional spatial division antenna system is utilized for a frequency band divided into a predetermined number of channels, adjacent channels in the frequency band having a predetermined bandwidth overlap. A plurality of antennas is distributed in a three-dimensional facetted configuration. A plurality of polarization planes is respectively associated with the plurality of antennas, each of the polarization planes being oriented at substantially 90 degrees relative all of the other polarization planes. Sets of non-overlapping channels of the predetermined number of channels are assigned to the polarization planes.

### FIELD OF THE INVENTION

The present invention relates to an antenna system supporting three-dimensional spatial division multiplexing access (3D-SDMA) for wireless communication devices, and more particularly to an antenna system having a plurality of antennas distributed in a three-dimensional facetted configuration. The antenna system will increase network capacity, enhance QoS, and reduce co-channel multipath interference by making good use of the polarization and spatial diversity in a high traffic density service area.

### BACKGROUND

Wireless Local Area Networks (WLAN) are used in the wireless transmission and reception of digitally-formatted data between sites within a building, between buildings, or between outdoor sites, using transceivers operating at frequencies in the range 2.4-2.5 GHz., 5.2-5.8 GHz., and others. Antennas operating over these frequency bands are required for the transceivers in WLAN devices. A WLAN infrastructure in conjunction with conventional wired LAN permits many devices, such as computers, to communicate with each other or with other devices such as servers or printers with freedom of mobility. The individual stations in a WLAN may be randomly positioned relative the other stations in the WLAN, therefore an omnidirectional antenna is often required for the WLAN's transceivers. One drawback of an omnidirectional antenna is its susceptibility to multipath interference, which can reduce signal strength by phase cancellation. This may result in unacceptable error rates for the digital information being transferred over a WLAN. Therefore it can only offer limited capacity to a certain service area due to lack of wave propagation directivity to reduce co-channel interference.

In many wireless systems it is necessary to employ some form of diversity technologies to increase network capacity and/or combat multipath effects in the communication system. The most popular techniques used in the wireless arena include but are not limited to: Time Division Multiplexing Access (TDMA), in which the communication is governed by synchronized time slot; Frequency Division Multiplexing Access (FDMA), in which the communication path is divided by channel; Code Division Multiplexing Access (CDMA), in which mutually orthogonal Pseudorandom Noise (PN) chip codes are employed; Spatial Division Multiplexing Access (SDMA), in which the service area is divided by sectors. It commonly appears in the cellular system in the form of three (3) sectors or six (6) sectors. In principle polarization can be used to realize another form of diversity. However it can only provide limited isolation between two perpendicular polarization plates (˜20 dB) in reality due to reflection, refraction and multipath interference.

Many known systems use a pair of ceramic patch antennas to form a spatially diverse antenna configuration. A ceramic patch antenna typically includes a ceramic substrate, a metalized patch formed on one surface of the substrate, and a ground plane disposed on the opposite surface of the substrate. A feedhole couples the metallized patch to the receiver/transmitter. The use of high dielectric constant materials for the ceramic substrate results in an antenna, which is physically small. However, ceramic patch antennas tend to be relatively expensive. Furthermore, connecting the antenna to a low cost circuit board often requires special connectors and cabling, which add cost to the system.

An example of the limitation of known WLAN antenna system is where, because of channel conflict, there is a limited amount of radio data bandwidth for clients or users of the radio system. For example: A college lecture hall would like to use a wireless data system to provide access to the students who attend lectures at the hall During the lectures the students would monitor information and mini video presentations that pertain to the lecture. Each student user requires x amount of data bandwidth, and the wireless data system provides “x*20” bandwidth on each of its radio channels. The wireless data system can only utilize “3” of its available channels in a confined area because of channel overlap and the resulting conflict of signal. This application would provide x*20*3=x*60, whereas “60” represents the total number of users that can communicate concurrently on the wireless data network. The problem occurs when the user number, in this case, exceeds 60.

### BRIEF DESCRIPTION OF THE DRAWINGS

The features of the present invention, which are believed to be novel, are set forth with particularity in the appended claims. The invention may best be understood by reference to the following description taken in conjunction with the accompanying drawings, in the several figures of which like reference numerals identify like elements, and in which:

FIG. 1 depicts a piconet in a wireless LAN in which the principles of the present antenna system may be practiced;

FIGS. 2 and 3 are graphs showing channels in a frequency band utilized by the present antenna system;

FIG. 4 depicts channels in different polarized planes for an embodiment of the antenna system;

FIG. 5 depicts a minimized point of contact of two different polarization planes for an embodiment of the antenna system;

FIG. 6 is a bottom view of the polarization planes for an embodiment of the antenna system;

FIG. 7 is a perspective view of the polarization planes for an embodiment of the antenna system; and

FIG. 8 is a side view of the polarization planes for an embodiment of the antenna system.

### DETAILED DESCRIPTION

While the present invention is susceptible of embodiments in various forms, there is shown in the drawings and will hereinafter be descried some exemplary and non-limiting embodiments, with the understanding that the present disclosure is to be considered an exemplification of the invention and is not intended to limit the invention to the specific embodiments illustrated.

One embodiment of the present antenna system is a three-dimensional spatial division antenna system for use in a frequency band divided into a predetermined number of channels, adjacent channels in the frequency band having a predetermined bandwidth overlap. A plurality of antennas is distributed in a three-dimensional facetted configuration. A plurality of polarization planes is respectively associated with the plurality of antennas, each of the polarization planes being oriented at substantially 90 degrees relative all of the other polarization planes. Sets of non-overlapping channels of the predetermined number of channels are assigned to the polarization planes.

The following are further embodiments of the present antenna system. Each of the sets of non-overlapping channels contains at least one respective channel of the predetermined number of channels. The antenna has predetermined radiation points, a respective antenna at a respective radiation point being one of a directional antenna and/or an omni-directional antenna. Furthermore, each radiation point of the predetermined radiation points is isolated by polarization from all other radiation points of the predetermined radiation points.

In one embodiment the antenna has four polarization planes that are oriented at substantially 90 degrees to one another and at substantially 45 degrees to a predetermined plane. The antenna may have at least a first set of antenna signals in a first polarized plane, a second set of antenna signals in a second polarized plane, a third set of antenna signals in a third polarized plane, a fourth set of antenna signals in a fourth polarized plane, each of the first, second, third, and fourth polarized planes being oriented at substantially 90 degrees to one another. Thus, the antenna has spatial three-dimensional diversity effected by three-dimensional polarization with isolation.

Embodiments of the antenna system exhibit important properties such as: spatial broadcast (diversity, isolation) on a three-dimensional level; spatial three-dimensional diversity by the application of three-dimensional polarization with isolation; creation of n radiation planes in a three-dimensional (diversity, isolation) orientation; application of multiple conflicting radio radiation sources oriented in a non-conflicting manner by the usage of diversity (polarization); isolation of conflicting radiation planes is repeatable over and over by an application of the present technique. The present technique can utilize both directional and omni-directional antennas at the radiation points. All points of radiation are isolated by a diversity or polarization relationship with the other points.

It is well known in signal processing that there are actually more than one type of diversity that can be used to increased signal reception: spatial, temporal (time), code, polarization, frequency, and pattern (angle), etc. Of these, only spatial, polarization and pattern make for a practical implementation in wireless LAN antenna systems.

Frequency diversity (i.e. FDMA) and code diversity (i.e. CDMA) have effectively already been taken into account in wireless LAN systems, since by definition the individual data links are “channelized” to isolate different networks form one another, and within each channel user traffics are multiplexed by CDMA technology. TDMA could be a complementary alternative to CDMA in terms of multiple access technology.

This leaves spatial, pattern and polarization as diversity options for wireless LAN. Spatial diversity is the most widely implemented form of diversity combining. Spatial diversity can be used to mitigates the problem of multiple signals by using two similar receive antennas separated by a fixed number of wavelengths. Given that the multipath interference is localized to a specific location (such as a first antenna), a second antenna will not suffer the same degradation.

One type of wireless LAN system is known as an 802.11 system (IEEE 802.11 systems include 802.11b, 802.11a, and 802.11g), which provides a communication channel between two electronic devices via a short-range radio link (˜300 feet). In particular, the 802.11 system operates in the unlicensed Industrial-Scientific-Medical (ISM) band.

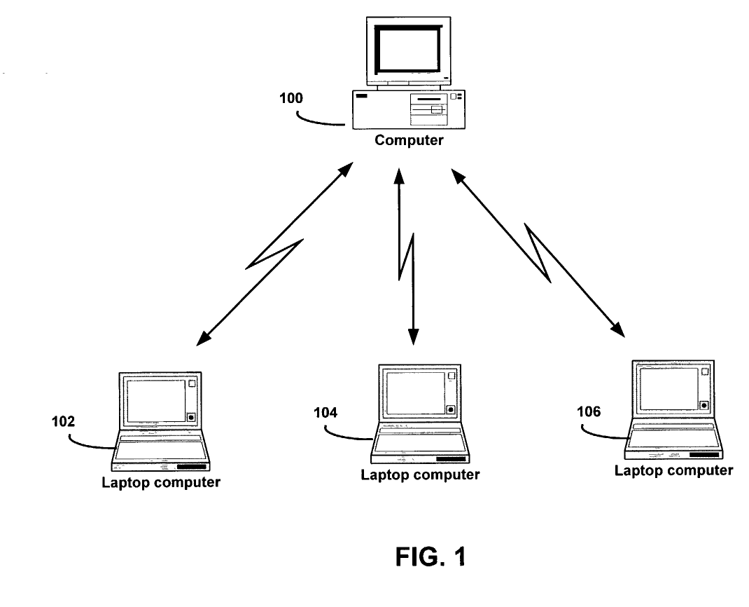

When a number of wireless devices having 802.11 systems are setup in a lecture hall, for example, then they form what is termed a piconet. FIG. 1 shows a main computer 100 that is wirelessly linked to laptop computers 102, 104, and 106. This is only one example, and various other types of equipment in other configurations may form a piconet or other network and utilize the present antenna system.

Antenna signals carry information between the computers 100, 102, 104 and 106 in FIG. 1. These antenna signals are electromagnetic waves when they travel through air. Electromagnetic waves in free space travel in a direction that is perpendicular to the direction(s) of oscillation of their associated electric and magnetic fields. For example, if an RF (radio frequency) wave is traveling in the z-direction, the electric field could be oscillating in either (or both) the x- and/or y-directions (referred to as the horizontal and vertical directions). As this wave encounters other structures, it bounces off and produces multiple copies as detailed above in the spatial diversity section. However, in addition to the now random phase of the multiple received signals, the reflected signals also exhibit changed polarization. Therefore, both a horizontally and vertically polarized receiver system is optimal for wireless LAN.

A Bluetooth signal travels through the air, and completes a cycle in approximately 12 cm. If the signal strikes a 12 cm antenna or fractions of it (½ or ¼ wavelength=6 or 3 cm), then the induced current will be much higher than if the signal struck a metal object that was not some appreciable fraction of the wavelength. This is known as antenna resonance. Every antenna has at least one exact resonance point. An antenna also transmits a stronger signal if it is resonant at the frequency used.

Three-dimensional spatial division multiple access is a complex antenna system implementation technique that allows n standard antennas to be distributed in a faceted manner that enhances effective signal coverage and effective signal distribution. This system increases the available amount of useable adjacent radio channels within a radio band by providing multiple minimal conflicting paths of radio signals to radio clients.

The antenna system provides management of diversity signals such that the signals are local in proximity, but are opposing each other in a three-dimensional faceted orientation of polarization. This allows theoretically infinite isolation. However, because of reflection and multi-path, a practical −20 db of standard isolation is a factor to be used redundantly when increasing the number of isolation planes in three dimensions from the same radio broadcast point on multiple adjacent radio channels. This minimizes channel conflict because of the multiple planes of isolation.

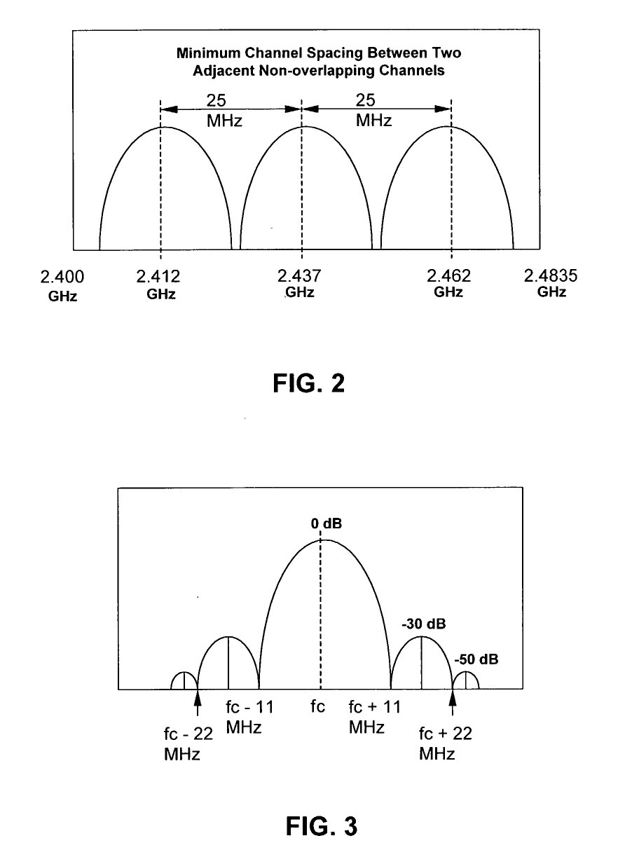

For example, in the 2.4 GHz ISM radio band there are 11 designated channels that correspond to frequencies that start at a center frequency of 2412 MHz with a bandwidth of +/−2.5 MHz for channel 1 and increase in 5 MHz steps for each channel through channel 11. Because of the channel bandwidth, only channels 1, 6 & 11 (see FIGS. 2 and 3) are non-overlapping or clear channels. This means that only channels 1, 6 & 11 can coexist in a given proximity to each other and that any other channel would conflict because of the bandwidth overlap.

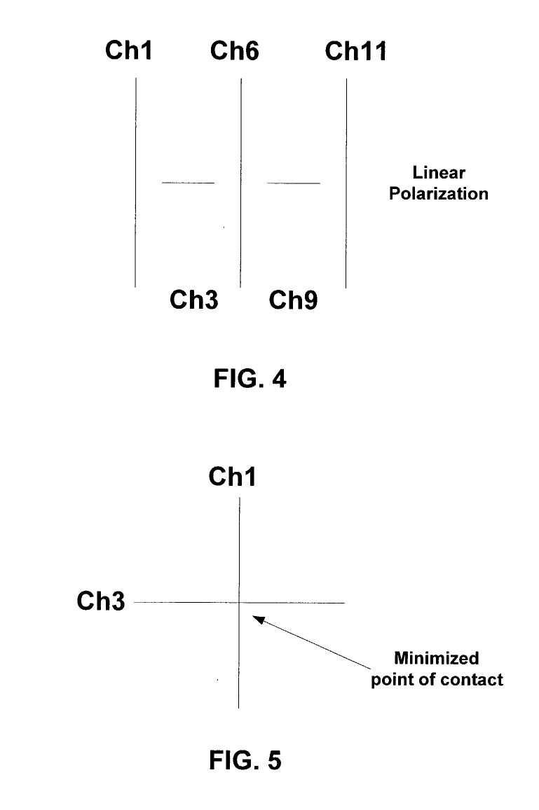

The present antenna system overcomes this conflict by allowing the other channels to exist on another polarization plane. As a basic example, RF waves can be separated into vertical and horizontal polarized waves from dipole type antennas, both of which are a type of linear polarization. Polarization is the figure traced out in time by the instantaneous electric field vector associated with the radiation field produced by an antenna. Electromagnetic waves in free space travel in a direction (plane) that is perpendicular to the direction(s) of oscillation of the electric and magnetic fields. For example, if an RF wave is traveling in the z-direction, the electric field could be oscillating in either (or both) the x-direction or y-direction (referred to as the horizontal and vertical directions). That is, if channels 1, 6 and 11 (see FIG. 4) were radiated on vertical polarized antennas and channels 3 and 9 were radiated on horizontal polarized antennas, the channel overlap conflict would only exist where the two polarized planes meet in space at a 90 degree angle to each other, as schematically depicted in FIG. 5. This minimizes the conflict by −20 db in practice, effectively nullifying any interference effect.

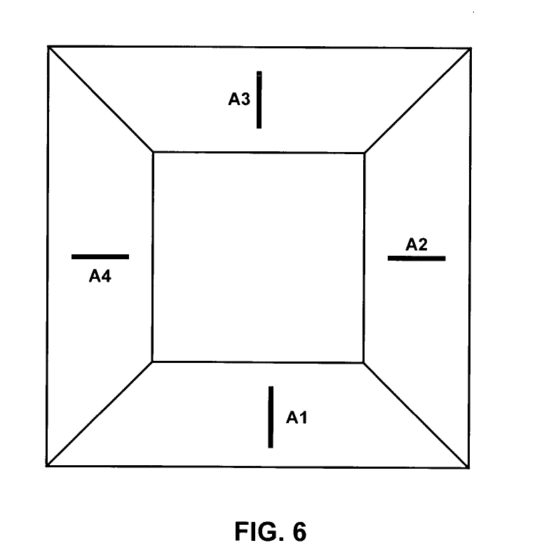

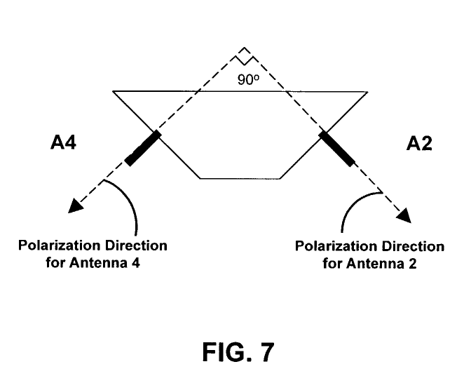

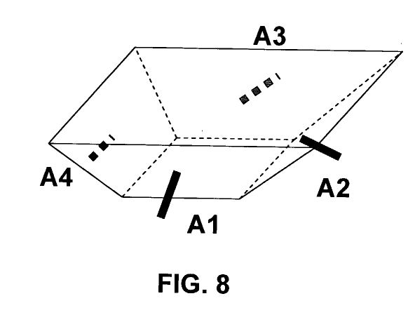

As depicted in FIG. 6 third and fourth planes, A3 and A4, are added to the first and second planes, A1 and A2, to form a box configuration. The third and fourth planes, A3 and A4, are 90 degrees opposed to the other planes, and all four planes are angled at 45 degrees to the horizon (also see FIG. 7). This changes the back-to-back 120 degree position of the two opposing planes in the box configuration to a faceted position that is a total of 90 degrees to each other (i.e. A1 is the 1^{st} Polarization Plane, A2 is the 2nd Polarization Plane, A3 is the 3rd Polarization Plane, A4 is the 4th Polarization Plane, etc.). By including the other two opposing planes in a faceted multi dimensional space, three-dimensional spatial division multiple access is effected (also see FIG. 8).

It is to be understood, of course, that the present invention in various embodiments can be implemented in hardware, software, or in combinations of hardware and software.

The present invention is not limited to the particular details of the apparatus and method depicted, and other modifications and applications are contemplated. Certain other changes may be made in the above-described apparatus and method without departing from the true spirit and scope of the invention herein involved. For example, the present invention may be utilized in other types of communication systems or other environments. It is intended, therefore, that the subject matter in the above depiction shall be interpreted as illustrative and not illuminating sense.

What is claimed is:

1. An antenna system, comprising:
a plurality of antennas, each of the antennas of the plurality of antennas having associated therewith a respective antenna signal;
the antennas of the plurality of antennas having a configuration such that at least some of the antenna signals are opposing each other in a three dimensional facetted orientation.

2. The antenna according to claim 1, wherein the antenna is utilized for a frequency band that is divided into a plurality of channels, and wherein the antenna has multiple planes of isolation between multiple adjacent channels in the frequency band.

3. The antenna according to claim 1, wherein the antenna has special three dimensional diversity with three dimensional polarization with isolation.

4. The antenna according to claim 1, wherein the antenna has predetermined radiation points, and wherein a respective antenna at a respective radiation point is one of a directional antenna and/or an omni-directional antenna.

5. The antenna according to claim 1, wherein the antenna has predetermined radiation points, and wherein each radiation point of the predetermined radiation points is isolated by polarization from all other radiation points of the predetermined radiation points.

6. The antenna according to claim 1, wherein the antenna has n antennas, and wherein the antennas form n radiation planes in a three dimensional configuration.

7. The antenna according to claim 1, wherein the antenna has four or more polarization planes that are oriented at substantially 90 degrees to one another and at substantially 45 degrees to a predetermined plane.

8. The antenna according to claim 1, wherein the antenna has a plurality of antenna elements, each of the antenna elements of the plurality of antenna elements having associated therewith a respective antenna signal, and wherein the antenna has at least a first set of antenna signals in a first polarized plane, a second set of antenna signals in a second polarized plane, and a third set of antenna signals in a third polarized plane, and wherein each of the first, second, and third polarized planes are oriented at substantially 90 degrees to one another.

9. The antenna according to claim 1, wherein the antenna has a plurality of antenna elements, each of the antenna elements of the plurality of antenna elements having associated therewith a respective antenna signal, and wherein the antenna has at least a first set of antenna signals in a first polarized plane, a second set of antenna signals in a second polarized plane, a third set of antenna signals in a third polarized plane, a fourth set of antenna signals in a fourth polarized plane, and wherein each of the first, second, third, and fourth or more polarized planes are oriented at substantially 90 degrees to one another.

10. The antenna according to claim 1, wherein the antenna has spatial three dimensional diversity effected by three dimensional polarization with isolation.

11. The antenna according to claim 1, wherein the antenna has a plurality of points of radiation, and wherein each point of radiation is isolated from all other points of radiation by polarization.

12. An antenna for use in a frequency band divided into a predetermined number of channels, adjacent channels in the frequency band having a predetermined bandwidth overlap, comprising:
a plurality of polarization planes, each of the polarization planes being oriented at substantially 90 degrees relative all of the other polarization planes; and
sets of non-overlapping channels of the predetermined number of channels being assigned to the polarization planes.

13. The antenna according to claim 12, wherein each of the sets of non-overlapping channels contains at least one respective channel of the predetermined number of channels.

14. The antenna according to claim 12, wherein the polarization planes are in a facetted configuration.

15. The antenna according to claim 12, wherein the antenna has predetermined radiation points, and wherein each radiation point of the predetermined radiation points is isolated by polarization from all other radiation points of the predetermined radiation points.

16. The antenna according to claim 12, wherein the antenna has at least four polarization planes that are oriented at substantially 90 degrees to one another and at substantially 45 degrees to a predetermined plane.

17. The antenna according to claim 12, wherein the antenna has spatial three dimensional diversity effected by three dimensional polarization with isolation.

18. The antenna according to claim 12, wherein the antenna has a plurality of points of radiation, and wherein each point of radiation is isolated from all other points of radiation by polarization.

19. An antenna system, comprising:
a plurality of antennas distributed in a three dimensional facetted configuration, each of the antennas of the plurality of antennas having associated therewith a respective antenna signal; and
the antenna signals being local in proximity, and at least some of the antenna signals opposing each other in the three dimensional facetted orientation.

20. The antenna according to claim 19, wherein the antenna has predetermined radiation points, and wherein a respective antenna at a respective radiation point is one of a directional antenna and/or an omni-directional antenna.

21. The antenna according to claim 19, wherein the antenna has predetermined radiation points, and wherein each radiation point of the predetermined radiation points is isolated by polarization from all other radiation points of the predetermined radiation points.

22. The antenna according to claim 19, wherein the antenna has four or more polarization planes that are oriented at substantially 90 degrees to one another and at substantially 45 degrees to a predetermined plane.

23. The antenna according to claim 19, wherein the antenna has at least a first set of antenna signals in a first polarized plane, a second set of antenna signals in a second polarized plane, and a third set of antenna signals in a third or more polarized plane, and wherein each of the first, second, and third polarized planes are oriented at substantially 90 degrees to one another.

24. The antenna according to claim 19, wherein the antenna has at least a first set of antenna signals in a first polarized plane, a second set of antenna signals in a second polarized plane, a third set of antenna signals in a third polarized plane, a fourth set of antenna signals in a fourth polarized plane, and wherein each of the first, second, third, and fourth polarized planes are oriented at substantially 90 degrees to one another.

25. The antenna according to claim 19, wherein the antenna has spatial three dimensional diversity effected by three dimensional polarization with isolation.

26. The antenna according to claim 19, wherein the antenna has a plurality of points of radiation, and wherein each point of radiation is isolated from all other points of radiation by polarization.

27. A three dimensional spatial division antenna system for use in a frequency band divided into a predetermined number of channels, adjacent channels in the frequency band having a predetermined bandwidth overlap, comprising:
a plurality of antennas distributed in a three dimensional facetted configuration;
a plurality of polarization planes respectively associated with the plurality of antennas, each of the polarization planes being oriented at substantially 90 degrees relative all of the other polarization planes; and
sets of non-overlapping channels of the predetermined number of channels being assigned to the polarization planes.

28. The antenna according to claim 27, wherein each of the sets of non-overlapping channels contains at least one respective channel of the predetermined number of channels.

29. The antenna according to claim 27, wherein the antenna has predetermined radiation points, and wherein a respective antenna at a respective radiation point is one of a directional antenna and an omni-directional antenna.

30. The antenna according to claim 27, wherein the antenna has predetermined radiation points, and wherein each radiation point of the predetermined radiation points is isolated by polarization from all other radiation points of the predetermined radiation points.

31. The antenna according to claim 27, wherein the antenna has four polarization planes that are oriented at substantially 90 degrees to one another and at substantially 45 degrees to a predetermined plane.

32. The antenna according to claim 27, wherein the antenna has at least a first set of antenna signals in a first polarized plane, a second set of antenna signals in a second polarized plane, and a third set of antenna signals in a third polarized plane, and wherein each of the first, second, and third polarized planes are oriented at substantially 90 degrees to one another.

33. The antenna according to claim 27, wherein the antenna has at least a first set of antenna signals in a first polarized plane, a second set of antenna signals in a second polarized plane, a third set of antenna signals in a third polarized plane, a fourth set of antenna signals in a fourth polarized plane, and wherein each of the first, second, third, and fourth polarized planes are oriented at substantially 90 degrees to one another.

34. The antenna according to claim 27, wherein the antenna has spatial three dimensional diversity effected by three dimensional polarization with isolation.

35. The antenna according to claim 27, wherein the antenna has a plurality of points of radiation, and wherein each point of radiation is isolated from all other points of radiation by polarization.

36. A method for transmitting and receiving antenna signals in a frequency band divided into a predetermined number of channels, adjacent channels in the frequency band having a predetermined bandwidth overlap, comprising the steps of:
transmitting and receiving antenna signals in polarization planes and in respective channels of the frequency band;
orienting each of the polarization planes at substantially 90 degrees relative to all of the other polarization planes; and
assigning sets of non-overlapping channels of the predetermined number of channels to the polarization planes.

37. The method according to claim 36, wherein each of the sets of non-overlapping channels contains at least one respective channel of the predetermined number of channels.

38. The method according to claim 36, wherein the method further comprises transmitting and receiving antenna signals in four polarization planes that are oriented at substantially 90 degrees to one another and at substantially 45 degrees to a predetermined plane.

39. The method according to claim 36, wherein the method further comprises; assigning at least a first set of antenna signals to a first polarized plane, a second set of antenna signals to a second polarized plane, and a third set of antenna signals to a third polarized plane, and wherein each of the first, second, and third polarized planes are oriented at substantially 90 degrees to one another.

40. The method according to claim 36, wherein the method further comprises; assigning least a first set of antenna signals to a first polarized plane, a second set of antenna signals to a second polarized plane, a third set of antenna signals to a third polarized plane, a fourth set of antenna signals to a fourth polarized plane, and wherein each of the first, second, third, and fourth polarized planes are oriented at substantially 90 degrees to one another.
